(19) United States
(12) Patent Application Publication
(10) Pub. No.: US 2026/0049031 A1
(43) Pub. Date: Feb. 19, 2026

(54) JOINT COMPOUNDS AND TEXTURES BUILDING COMPOSITIONS INCLUDING FLOTATION TAILINGS OF MILLED ORE AS FILLER AND METHODS OF MAKING THE BUILDING COMPOSITIONS

(71) Applicant: UNITED STATES GYPSUM COMPANY, CHICAGO, IL (US)

(72) Inventors: Phanindra KODALI, Mundelein, IL (US); Christian Terrell HUCH, Gurnee, IL (US); David Daniel PELOT, Chicago, IL (US); Naveen Kumar PUNATI, Kildeer, IL (US)

(73) Assignee: UNITED STATES GYPSUM COMPANY, CHICAGO, IL (US)

(21) Appl. No.: 19/039,013

(22) Filed: Jan. 28, 2025

Related U.S. Application Data
(60) Provisional application No. 63/683,024, filed on Aug. 14, 2024.

(51) Int. Cl. C04B 18/12; C04B 14/28; C04B 24/24; C04B 28/14; C04B 103/44; C04B 111/00; C04B 111/10

(52) U.S. Cl. CPC C04B 18/12; C04B 14/28; C04B 24/24; C04B 28/14; C04B 2103/44; C04B 2111/00482; C04B 2111/00672; C04B 2111/1006

(57) ABSTRACT

A building composition, such as a joint compound or texture, including flotation tailings of mined ore as a primary filler, and method of making the building composition. The joint compound may be a drying type joint compound or a setting type joint compound. The joint compound or texture may also include at least one secondary filler. The setting type joint compound may also include calcium sulfate hemihydrate.

### FIELD OF THE INVENTION

This invention relates generally to building compositions, such as joint compounds and textures, that include particles of flotation tailings of milled ore as filler and methods of making the building compositions

### BACKGROUND OF THE INVENTION

In the construction of buildings, one of the most common building elements is gypsum wallboard, often known as drywall or gypsum paneling, used in the construction of walls and/or ceilings. The board may be composed of any of a variety of materials, including but not limited to, cementitious materials such as, for example, cement or gypsum. Walls made from gypsum wallboard are traditionally constructed by affixing the panels to wood studs or metal framing, and treating the joints between adjoining panels with a specially prepared adhesive called a joint compound. Gypsum panels easily accommodate walls that are unusual in size and can be shaped around structural elements such as beams or pipes. The side edges of the drywall panels are tapered, thus allowing the joint compound to be applied to the seam, between adjoining panels, in such a way that a monolithic surface is created when finished.

It is well known in the art that finishing a joint between boards involves at least three steps. First, a thin layer of joint compound is applied to the boards over the joint, and a liquid-permeable paper or fiberglass tape is embedded into it. Next, a second coat of joint compound is applied over the embedded joint tape. The second coat of joint compound typically extends approximately two inches beyond the edges of the joint tape. Finally, a third coat of joint compound is applied over the first two coats, where the third coat typically extends even further out from the edges of the joint tape. Both the second and third coat may be subsequently lightly sanded upon drying. Further coats may be necessary to achieve the desired level of finish in certain occupied spaces with critical lighting. Joint compounds are also used to make repairs of defects, such as uneven surfaces, holes, depressions, gaps, dents, and other imperfections including those around electrical boxes, piping and duct work, as well as corners created by the intersection of drywall boards.

There are several categories of joint compounds. Drying type compounds cure through the evaporation of water, whereas setting type joint compounds chemically react with water during the curing process. Setting type joint compounds typically use calcium sulfate hemihydrate, also known as stucco or Plaster of Paris, as a base. When water is added to the setting type powder, it reacts with the calcium sulfate hemihydrate via a hydration reaction to form an interlocking matrix of calcium sulfate dihydrate crystals. The interlocking crystal matrix gives the compound increased strength. The benefit of a setting type joint compound over a drying type is an independence from having to wait for the joint compound to be completely dry prior to further finishing, as well as less shrinkage and cracking, and a higher overall strength of the finished joint. Drying type joint compounds have the advantage of ease of use, as they typically come in a ready mixed form, with water being added and mixed by the manufacturer. A third type of joint compound combines the setting action of a calcium sulfate hemihydrate based compound with the ease of use of a ready mixed compound. The properties of a ready mixed setting type joint compound are taught in U.S. Pat. No. 5,746,822 to Espinoza, incorporated herein by reference. U.S. Pat. No. 5,746,822 to Espinoza et al discloses a cementitious composition of the setting type which can be caused to set and harden upon introduction of an accelerator. The cementitious base composition contains calcium sulfate hemihydrate as a principal filler material and certain non-calcium bearing phosphate additives which prevent setting in the presence of water. Or the ready-mixed cementitious composition can be used as a drying type joint compound without the accelerator. Additional ingredients which may be used in the joint compound include preservatives, wetting agents, defoamers and plasticizers.

Between coats of joint compound, and before the wall is decorated, the joint compound is sanded to even the surface.

In the construction of buildings it is also known to apply Texture coating compositions (also known in the industry as textures) to a building surface such as a wall or ceiling to apply a textured appearance to the building surface. Textures are applied to wallboards on walls and ceilings as a decorative finish. Textures and drying-type joint compounds do not contain calcium sulfate hemihydrate. Generally, textures do not contain latex. The typical main filler in textures and drying-type joint compound is calcium carbonate. However, textures are different from joint compounds. Unlike drying type joint compound, the texture is applied over the entire drywall surface for both walls and ceilings, not just the joints. Textures are typically applied either by using a spray gun or by hand tools such as brushes, trowels, or sponges to achieve desired patterns. While using the spray gun, pressure, and nozzle size are adjusted to achieve desired texture patterns. Textures are applied over drywall walls or ceilings to enhance the visual appeal of surfaces and can hide imperfections. Unlike drying type joint compounds, no sanding is needed. Customers typically buy textures in the powder form. At the job site they mix the powder in water and apply over the walls and ceilings. Some textures are also available in ready mix form which includes the texture ingredients already combined with water.

Calcium carbonate is the main filler used in joint compounds and textures. However, Calcium carbonate costs have increased in the past years.

In the United States, mining is a major industry. The ore from the mine is separated to recover the desired metal or other product, but this also produces a waste stream of tailings as a remainder. Mine tailings are generally uniform in character and size and usually consist of hard, angular solid particles with a high percentage of fines. The major constituents of mine tailings are silica and alumina although in many cases they also contain traces of heavy metals. Disposal of mine tailings causes major concerns in the mining industry. If copper mining is taken as an example, for every ton of rock that is processed, only 10 kilograms of copper is extracted and the remaining 990 kilograms of waste material is going to tailings. It would be desirable to find a use for mineral ore tailings.

### SUMMARY OF THE INVENTION

This invention relates generally to building compositions, such as joint compounds and texture coating material (also known as “textures”), comprising flotation tailings of mined ore as a filler.

The building composition, wherein the building composition is a joint compound or a texture coating material, comprising a mixture of ingredients comprising:
flotation tailings of mined ore as a primary filler,
wherein the tailings of mined ore is at least 1 weight percent (wt %), typically at least 25 wt %, more typically at least 50 wt %, of the building composition on a dry (water free) basis, typically ranges of:
   55 wt % to 95 wt % of the building composition on dry (water free) basis for drying type joint compound,
   30 wt % to 60 wt % of the building composition on dry (water free) basis for setting type joint compound, and
   85 wt % to 95 wt % of the building composition on dry (water free) basis for textures;
a binder at about 0.5 to about 15 wt %, typically about 0.5 to about 8 wt %, of the building composition on a dry basis;
a polymer thickener at 0 to about 3 wt %, typically about 0.05 to about 3 wt %, of the building composition on a dry basis;
an additive at 0 to about 10 wt % of the building composition on a dry basis.

The building composition may be a drying-type (“DT”) joint compound,
wherein the tailings of mined ore is at least 25 wt %, preferably at least 50 wt %, more preferably at least 75 wt %, typically about 25 to about 98 wt % or about 50 to about 95 wt % of the joint compound on a dry basis,
further comprising secondary filler at 0 to about 50 wt % of the joint compound on a dry basis, wherein the secondary filler, if present, comprises any of calcium carbonate, calcium sulfate dihydrate, calcium sulfate anhydrite, or a mixture thereof;
wherein the tailings of mined ore and the secondary filler total at least 45 weight percent (wt %), preferably at least 60 wt %, more preferably at least 75 wt % of the drying-type joint compound on a dry basis;
wherein the binder is about 0.5 to about 15 wt % of the joint compound on a dry basis; and
wherein the polymer thickener is about 0.05 to about 3 wt % of the building composition on a dry basis;
wherein the additive is 0 to about 10 wt % of the building composition on a dry basis.

The building composition may be a ready-mix, drying-type (“DT”) joint compound comprising joint compound components and water,
wherein the joint compound components comprise the tailings of mined ore, the binder, the polymer thickener, the additive, and optionally a secondary filler;
wherein the tailings of mined ore is at least 25 wt %, preferably at least 45 wt %, more preferably at least 75 wt %, typically about 50 to about 95 wt % of the joint compound on a dry basis,
wherein the secondary filler is 0 to 50 wt % of the drying-type joint compound on a dry basis, wherein the secondary filler, if present, preferably comprises any of calcium carbonate, calcium sulfate dihydrate, calcium sulfate anhydrite, or a mixture thereof;
wherein the tailings of mined ore and the secondary filler total at least 45 wt. %, preferably at least 75 wt % of the drying-type joint compound on a dry basis;
wherein the binder is about 0.5 to about 15 wt % of the drying-type joint compound on a dry basis;
wherein the polymer thickener is about 0.05 to about 3 wt % of the drying-type joint compound on a dry basis;
wherein the additive is up to 10 wt % of the drying-type joint compound on a dry basis; and
wherein the water is at a weight ratio of water to joint compound components of about 1:3 to about 3:1.

The building composition may be a setting-type (“ST”) joint compound, wherein
the setting-type joint compound further comprising at least 20 wt % calcium sulfate hemihydrate on a dry basis;
wherein the tailings of mined ore is from 1 to 60 wt % of the setting-type joint compound on a dry basis,
the setting-type joint compound further comprising 0 to 25 wt % secondary filler on a dry basis, wherein the secondary filler, if present, preferably comprises any of calcium carbonate, calcium sulfate dihydrate, calcium sulfate anhydrite, or a mixture thereof;
wherein the total of the calcium sulfate hemihydrate, the tailings of mined ore, and the secondary filler is at least 60 wt % of the setting-type joint compound on a dry basis;
the binder is about 0.5 to about 8 wt % of the setting-type joint compound on a dry basis;
the polymer thickener is about 0.05 to about 2 wt % of the setting-type joint compound on a dry basis; and
the additive is up to about 10 wt % of the setting-type joint compound on a dry basis.

The building composition may be a ready-mixed, setting-type joint compound comprising joint compound components and water
wherein the ready-mixed, setting-type joint compound comprises joint compound components and water;
wherein the joint compound components comprise the tailings of mined ore, the binder, the polymer thickener, the dedusting agent, the additive, and further comprise calcium sulfate hemihydrate, a set retarder, and optionally a secondary filler, wherein the secondary filler, if present, preferably comprises any of calcium carbonate, calcium sulfate dihydrate, calcium sulfate anhydrite, or a mixture thereof;
wherein:
the calcium sulfate hemihydrate is at least 20 weight percent (wt %) of the ready-mixed, setting-type joint compound on a dry basis;
the tailings of mined ore is about 1 wt % to about 60 wt % of the ready-mixed, setting-type joint compound on a dry basis;
the total calcium sulfate hemihydrate, tailings of mined ore and the secondary filler is at least 60 wt % of the ready-mixed, setting joint compound on a dry basis;
the set retarder is about 0.001 wt % to about 2 wt % of the ready-mixed, setting-type joint compound on a dry basis;
the binder is about 0.5 wt % to about 8 wt % of the ready-mixed, setting-type joint compound on a dry basis;
the polymer thickener is about 0.05 wt % to about 2 wt % of the ready-mixed, setting-type joint compound on a dry basis;
the additive is up to 10 wt % of the ready-mixed, setting-type joint compound on a dry basis; and
the water is at a ratio of water to joint compound components of about 1:3 to about 3:1.

The building composition may be a texture coating material,
wherein the tailings of mined ore is at least 25 wt %, preferably at least 50 wt %, more preferably at least 75 wt %, typically about 25 to about 95 wt % or about 85 to about 96 wt % of the texture coating material on a dry basis;
0.05 wt. % to 3 wt. % polymer thickener;
0.5 wt. % to 8 wt. % binder;
wherein the texture coating material further comprises water;
   wherein the texture coating material has an absence of latex

The invention also provides a method of using the building composition of the invention, comprising applying the building composition to boards, joint tape, and/or another layer of the building composition.

The invention also comprises a method of making the building composition of the invention, comprising combining the ingredients of the building composition to make a mixture which is the building composition of the invention.

In particular, the invention comprises a method of making the building composition of the invention, comprising combining:
the tailings of mined ore in an amount of at least 1 weight percent (wt %), typically at least 25 wt %, more typically at least 50 wt %, of the building composition on a dry (water free) basis;
the binder at 0 to about 15 wt % of the building composition on a dry basis;
the polymer thickener at 0 to about 3 wt % of the building composition on a dry basis;
the additive at 0 to about 10 wt % of the building composition on a dry basis;
to form the mixture;
wherein the building composition is a joint compound or a texture coating material.

The flotation tailings of mined ores, preferably Copper ores and/or Zinc ores, are primary fillers. The flotation tailings are solid particles. Typically the joint compounds include fillers, thickeners, starches, clays, binders, and preservatives, and in the ready mix joint compounds, water. Typically the textures include fillers, thickeners, starches (as binders), clays, binders, preservatives, and water.

Other advantages, benefits and aspects of the invention are discussed below, are illustrated in the accompanying figures, and will be understood by those of skill in the art from the more detailed disclosure below. All percentages, ratios and proportions herein are by weight (e.g., wt %), unless otherwise specified. All wt. % are on a dry basis (water free) unless otherwise indicated or apparent. A wet basis is a water inclusive basis.

As used in the present specification at the very least, and not as an attempt to limit the application of the doctrine of equivalents to the scope of the claim, each numerical parameter modified by the term “about” should at least be construed in light of the number of reported significant digits and by applying ordinary rounding techniques.

### BRIEF DESCRIPTION OF THE DRAWINGS

FIG. 1 is a simplified schematic diagram of processing mining materials and separating concentrate from tailings by flotation.

FIG. 2 shows a schematic drawing of how mined ore is processed to recover product and produce flotation mining tailings as a by-product.

FIG. 3 is a plot of XRD analysis of a copper mining flotation tailings sample.

FIG. 4 illustrates a spray gun apparatus used in examples.

FIG. 5 shows a spatula used to scrape over the dry texture surface in examples.

FIG. 6 shows the Splatter and Orange Peel results of the texture while still wet after application to a board

### DETAILED DESCRIPTION OF THE INVENTION

The present invention is directed, at least in part, to building compositions that include flotation tailings of milled ore as filler. More specifically, the building compositions are joint compounds or textures that include flotation tailings of milled ore as filler.

### Joint Compounds and Texture Coating Materials

The building compositions of the invention, wherein the building composition is a joint compound or a texture coating material, comprise:
flotation tailings of mined ore as a primary filler,
wherein the tailings of mined ore is at least 1 weight percent (wt %), typically at least 25 wt %, more typically at least 50 wt %, of the building composition on a dry (water free) basis, typically ranges of:
   55 wt % to 95 wt % of the building composition on dry (water free) basis for drying-type joint compound,
   30 wt % to 60 wt % of the building composition on dry (water free) basis for setting type joint compound, and
   85 wt % to 95 wt % of the building composition on dry (water free) basis for textures;
a binder at about 0.5 to about 15 wt %, typically about 0.5 to about 8 wt %, of the building composition on a dry basis;
a polymer thickener at 0 to about 3 wt %, typically about 0.05 to about 3 wt %, of the building composition on a dry basis;
optionally, a dedusting agent at 0 to about 3 wt %, or typically about 0.3 to about 3 wt %, of the building composition on a dry basis; and
an additive at 0 to about 10 wt % of the building composition on a dry basis.

Total of flotation tailings of milled ores, secondary filler (if present) and calcium sulfate hemihydrate (if present) is at least 45 weight percent (wt %), preferably at least 60 wt % of the building composition on a dry basis.

The invention provides “drying-type” joint compounds, “ready-mixed, drying-type” joint compounds, “setting-type” joint compounds, or “ready-mixed, setting-type” joint compounds that include flotation tailings of milled ores. The terms drying-type” joint compounds, “ready-mixed, drying-type” joint compounds, “setting-type” joint compounds, and “ready-mixed, setting-type” joint compounds are terms of art. The joint compounds including the flotation tailings of milled ores may further include at least one secondary filler (e.g., calcium sulfate dihydrate, calcium carbonate, or calcium sulfate anhydrite). They may also include a binder, polymer thickener, starch, plasticizer, and various other additives such as a preservative. The setting type joint compounds and “ready-mixed, setting-type” joint compounds typically also include calcium sulfate hemihydrate.

Drying-type joint compositions can be dry powders that are mixed with water at the job site. Drying-type joint compounds harden when the water evaporates and the compound dries. Drying-type joint compounds substantially contain a filler component. Drying-type joint compounds contain inert filler component and have an absence of solid materials, such as calcium sulfate hemihydrate, that set when mixed with water. Prior to use (generally during manufacturing), the filler, a binder, a thickener, a dedusting agent (optional), and optionally several other ingredients are mixed for a specific time with water to produce the drying-type joint compound. Such a composition has a basic pH. Once the drying-type joint compound is applied to the wallboard panels, the composition dries (i.e., water evaporates) and a dry, relatively hard cementitious material remains.

Drying-type joint compositions can also be Ready-mixed, drying-type joint compositions. These are drying-type joint compositions pre-mixed with water during manufacturing and require little or no addition of water at the job site.

TABLE 1 provides examples of drying-type joint compound formulations of the present invention for ready-mix, drying-type joint compound where the water is present in the mixture or dry powder (water free) drying-type joint compound to which the water is later added with the other components in the prescribed amounts. Typically values for components in a single column of the table are used together. However, values for a component from a column can be substituted for that component into another column and used with the values for other components in that column where mathematically permitted.

TABLE 1
Drying-type (DT) ready mix joint compound formulations

| | Useable | Preferred | Typical | More typical |
|---|---|---|---|---|
| Component | range | range | range | range |
| Tailings of mined ore (wt % | At least 25 | At least 50 | 25 to 98 | 50 to 95 or |
| on a dry basis) | | | | 55 to 95 |
| Secondary Filler (wt % on | 0 to 50 | 0 to 25 | 3 to 25 | 4 to 25 |
| a dry basis) | | | | |
| Total of tailings of mined | at least 45 | at least 60 | at least 75 | at least 80 |
| ore and Secondary Filler | | | | |
| (wt % on dry basis) | | | | |
| Binder (wt % on a dry basis) | 0.5 to 15 | 1 to 10 | 1 to 10 | 1 to 8 |
| Polymer Thickener (wt % on | 0.05 to 3 | 0.1 to 3 | 0.1 to 2 | 0.5 to 2 |
| a dry basis) | | | | |
| Other Additives (wt % on a | up to 10 | up to 10 | 0.01 to 10 | 0.1 to 10 |
| dry basis) | | | | |
| Water (weight ratio of water | 1:3 to 3:1 | 1:3 to 2:1 | 1:3 to 1:1 | 1:2 to 1:1 |
| to joint compound components) | | | | |

A setting-type joint compound generally includes calcium sulfate hemihydrate (CaSO₄·½H₂O; also referred to as calcined gypsum). A setting type joint compound is a joint compound that chemically sets rather than merely dries. Upon being mixed with water, the calcium sulfate hemihydrate is hydrated, which causes dihydrate crystals to form and interlock. Once completed, a dry, relatively hard cementitious material remains. The rehydration of calcium sulfate hemihydrate normally takes place over a fairly short period of time. Therefore, setting-type compound compositions are typically supplied to the job site in the form of a dry powder to which the user then adds a sufficient amount of water to give the compound a suitable consistency to be applied to the wall.

TABLE 2 provides examples of the dry powder of setting-type joint compound formulations of the present invention. Water can be added to the dry powder before use at a weight ratio of water to joint compound components of about 1:3 to about 3:1, preferably about 1:2. Typically values for components in a single column of the table are used together. However, values for a component from a column can be substituted for that component into another column and used with other values for other components in that column where mathematically permitted.

TABLE 2
Setting-type (ST) joint compound formulations

| | Useable | Preferred | Typical | More typical |
|---|---|---|---|---|
| Component (wt % on a dry basis) | range | range | range | range |
| Calcium sulfate hemihydrate | At least 20 | 20 to 80 | 35 to 75 | 35 to 65 |
| Tailings of mined ore | 1 to 60 | 10 to 60 | 20 to 60 | 30 to 60 |
| Secondary filler | 0 to 25 | 0 to 25 | 0 to 25 | 0 to 25 |
| Total calcium sulfate | At least 60 | At least 85 | 85 to 98 | 85 to 98 |
| hemihydrate, tailings of mined | | | | |
| ore, and secondary filler | | | | |
| Set Accelerator | 0.001 to 2 | 0.01 to 2 | 0.1 to 1 | 0.25 to 1.0 |
| Set Retarder | 0.001 to 2 | 0.01 to 2 | 0.1 to 1 | 0.25 to 0.75 |
| Binder | 0.5 to 8 | 1 to 8 | 1 to 4 | 1 to 4 |
| Polymer Thickener | 0.05 to 2 | 0.1 to 2 | 0.1 to 1 | 0.1 to 1 |
| Other Additives | up to 10 | up to 10 | 0 to 5 | 0.1 to 5 |

A ready-mixed, setting-type joint compound is an aqueous slurry setting-type joint compound that contains a sufficient concentration of set retarder to prevent setting before use. When ready to use, an accelerator is added in an amount to achieve a desired set time.

TABLE 3 provides examples of the ready-mixed, setting-type joint compound formulations of the present invention. Typically values for components in a single column of the table are used together. However, values for a component from a column can be substituted for that component into another column and used with other values for other components in that column where mathematically permitted.

TABLE 3
Ready-mixed, setting-type joint compound formulations

| | Useable | Preferred | Typical | More typical |
|---|---|---|---|---|
| Component | range | range | range | range |
| Calcium Sulfate Hemihydrate | At least | 20 to 80 | 35 to 75 | 35 to 65 |
| (wt % on dry basis) | 20 | | | |
| tailings of mined ore (wt % on a | 1 to 60 | 10 to 60 | 20 to 60 | 30 to 60 |
| dry basis) | | | | |
| secondary filler (wt. % on a dry | 0 to 25 | 0 to 25 | 0 to 25 | 0 to 25 |
| basis) | | | | |
| Total calcium sulfate | At least | At least | 85 to 98 | 85 to 98 |
| hemihydrate, tailings of mined | 60 | 85 | | |
| ore, and secondary filler (wt. % | | | | |
| on a dry basis) | | | | |
| Set Accelerator (wt % on dry | 0.001 to 2 | 0.01 to 2 | 0.1 to 1 | 0.25 to 1.0 |
| basis) | | | | |
| Set Retarder (wt % on dry basis) | 0.001 to 2 | 0.01 to 2 | 0.1 to 1 | 0.25 to 0.75 |
| Binder (wt % on a dry basis) | 0.5 to 8 | 1 to 8 | 1 to 4 | 1 to 4 |
| Polymer Thickener (wt % on a dry | 0.05 to 2 | 0.1 to 2 | 0.1 to 1 | 0.1 to 1 |
| basis) | | | | |
| Other Additives (wt % on a dry | up to 10 | up to 10 | 0 to 5 | 0.1 to 5 |
| basis) | | | | |
| Water (weight ratio of water to | 1:3 to 3:1 | 1:3 to 2:1 | 1:3 to 1:1 | 1:2 |
| joint compound components) | | | | |

TABLE 4 provides examples of texture coating materials of the present invention. They are similar to the values for drying-type joint compound formulations of the present invention for ready-mix, drying-type joint compound where the water is present in the mixture or water is added at the job site. However, there are differences. The texture coating materials have no latex. Also, the texture coating materials have no calcium sulfate hemihydrate. A sanding step is not required for textures. Typically values for components in a single column of the table are used together. However, values for a component from a column can be substituted for that component into another column and used with other values for other components in that column where mathematically permitted.

TABLE 4
Texture coating materials

| | Useable | Preferred | Typical | More typical |
|---|---|---|---|---|
| Component | range | range | range | range |
| Tailings of mined ore (wt % on | At least 25 | At least 50 | 25 to 98 | 85 to 95 |
| a dry basis) | | | | |
| Secondary Filler (wt % on a | 0 to 50 | 0 to 40 | 0 to 50 | 0 to 10 |
| dry basis) | | | | |
| Total of tailings of mined ore | at least 75 | at least 75 | at least 75 | at least 85 |
| and Secondary Filler (wt % on | | | | |
| dry basis) | | | | |
| Polymer Thickener (wt % on | 0.05 to 3 | 0.1 to 3 | 0.1 to 2 | 0.5 to 2 |
| a dry basis) | | | | |
| Binder other than latex | 0.5 to 8 | 1 to 8 | 1 to 4 | 1 to 4 |
| (wt % on a dry basis)* | | | | |
| Other Additives (wt % on a | up to 10 | up to 10 | 0.01 to 10 | 0.1 to 10 |
| dry basis) | | | | |
| Water (weight ratio of water to | 1:3 to 10:1 | 1:3 to 7:1 | 1:3 to 5:1 | 1:3 to 5:1 |
| joint compound components) | | | | |

*Starch or pregelatinized starch are preferred as a binder for textures.

### Flotation Tailings of Mined Ore

Tailings are a by-product of mining. After ore containing an economically-recoverable commodity is mined from the earth, that commodity is extracted in a processing plant or mill. After the commodity of value is extracted from the ore material, the resultant waste stream is termed “tailings”. In mining, tailings or tails are the materials left over after the process of separating the valuable fraction from the uneconomic fraction (gangue) of an ore. Tailings are different from overburden, which is the waste rock or other material that overlies an ore or mineral body and is displaced during mining without being processed.

Thus, most mining tailings contain significant amount of clay materials, for example, kaolin minerals, which is an abundant source of Si and Al. Kaolinite, Al2[Si₂O₅](OH)₄, is the main phase of the kaolin group of clay minerals. It is formed when anhydrous aluminosilicate found in feldspar rich rock is altered by weathering or hydrothermal processes. The kaolinite crystal structure is composed of a plane of SiO₄ tetrahedra linked by oxygen atoms parallel to a plane of AlO₂(OH)₄ octahedra.

Most clay materials include hydrated silicates of aluminium with impurities that can typically include quartzite, feldspar, muscovite, metal oxides and organic matter. A large variety of clay materials can be used in the present invention. Kaolin clays are especially suitable. Types of clays that can be used in the present invention include kaolinite (Al₄Si₄O₁₀(OH)₈), halloysite (Al₂Si₂O₅(OH₄) and montmorillonite (Al₄(Si₄O₁₀)₂(OH)₄·nH₂O)). Other materials that include kaolinite (also known as kaolin), halloysite or montmorillonite phases and can be used in the present invention include mining tailings, such as mining tailings from kaolin mining, coal gangue kaolin, bentonite clays and bauxite mine or flotation tailings, coal flotation tailings and bauxite.

There are different mineral processing techniques. Below is a list of different types of tailings generated by them. Typically the particle size of the tailings employed in the invention has 100% passing 50 mesh screen, for example 100% passing 100 mesh or 100% passing 200 mesh. 50 mesh screen is a spacing of 297 microns. Copper, Zinc and Iron tailings are typical tailings employed in the present invention. However, Copper and Zinc tailings are the preferred tailings. Less preferably tailings such as coal tailings are employed.

The invention typically does not use the following tailings.
1. Tailings from rare earth elements are very dangerous. High level of radioactive materials and heavy metals are in them.
2. Tailings from Asbestos contain asbestos minerals which are harmful when inhaled.
3. Uranium tailings contain the radioactive decay products from the uranium decay chains, mainly the U-238 chain, and heavy metals. Long-term storage or disposal of tailings may pose a danger for public health and safety.
4. Lead tailings because they might contain heavy metals which are dangerous.
5. Not all Gold tailings but the ones that involve cyanide in processing can result in tailings with residual cyanide compounds.

There are different mineral processing techniques. Below is the list of different types of tailings generated by them.
Flotation tailings
Heavy media separation tailings
Gravity separation tailings
Magnetic separation tailings
Hydrometallurgical tailings
Heap leaching tailings
Tailings from comminution

The present invention deals with the flotation tailings.

Flotation, in mineral processing, is a method used to separate and concentrate ores by altering their surfaces to a hydrophobic or hydrophilic condition—that is, the surfaces are either repelled or attracted by water. The flotation process was developed on a commercial scale early in the 20th century to remove very fine mineral particles that formerly had gone to waste in gravity concentration plants. Flotation has now become the most widely used process for extracting many minerals from their ores. Flotation is widely used to concentrate copper, lead, and zinc minerals, which commonly accompany one another in their ores.

Most kinds of minerals require coating with a water repellent to make them float. By coating the minerals with small amounts of chemicals or oils, finely ground particles of the minerals remain unwetted and will thus adhere to air bubbles. The mineral particles are coated by agitating a pulp of ore, water, and suitable chemicals. The latter bind to the surface of the mineral particles and make them hydrophobic. The unwetted particles adhere to air bubbles and are carried to the upper surface of the pulp, where they enter the froth; the froth containing these particles can then be removed. Unwanted minerals that naturally resist wetting may be treated so that their surfaces will be wetted and they will sink. These are the flotation tailings.

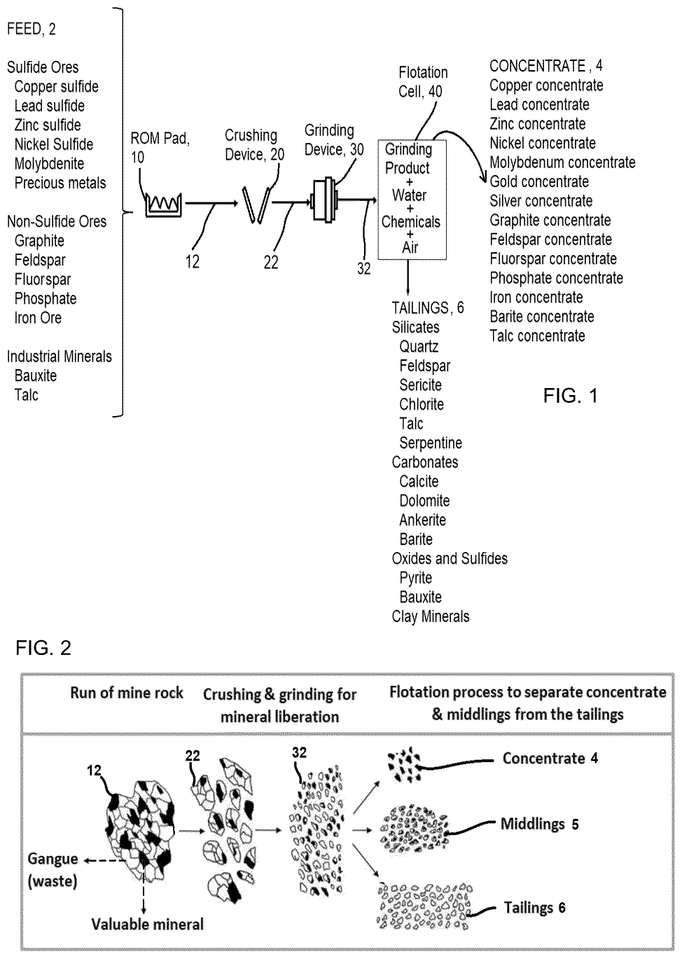

In particular, the tailings are the particles in a waste stream produced in conventional mining and recovery processes as a remainder after milling the ore and subjecting the milled ore to flotation to recover product. FIG. 1 shows a typical ore separation and product recovery process. During the mining process the rock formation is blasted to recover the run of the mine rock (ROM) ore. The feed 2 typically may comprise any one or more of Sulfide Ores, Non-sulfide Ores, and Industrial Minerals. Typical Sulfide Ores are any one or more of Copper Sulfide, Lead sulfide, Zinc sulfide, Nickel sulfide, Molybdenite, and Precious Metals. Typically Copper Sulfide. Typical Non-sulfide Ores are any one or more of such as Graphite, Feldspar, Fluorspar, Phosphate, and/or Iron Ore. Typical Industrial Minerals are Bauxite and/or Talc. The run of the mine (ROM) rock ore feed 2 is typically rocks having a weight average largest dimension of greater than 5 inch. However, these ROM rock sizes may change based on ore hardness. ROM pad would contain fine rocks/powder as well but typically in small quantity. For example, if the ore type is too soft, ROM rocks can be less than 5 inch in largest dimension. For example, a typical weight average ROM rock size may range from 3 to 6 inches or 3 to 5 inches. This feed 2 of ROM rocks are collected, for example on Run of Mine (ROM) Pad 10, and then sent as a ROM rocks stream 12 to be crushed in a crushing device 20 to crushed rocks 22 typically about 1 inch in weight average size, for example 0.75-1.25 inches. However, the size to which the ROM rocks are crushed may change from one plant to another plant. For example, it may vary depending on the screen that is deployed by the mining company. The crushed rocks 22 are then ground to a fine powdered rock in a grinding device 30 as known in the art to ground fine powdered ground rock particles 32 having a size ranging from about 5 to about 200 μm in weight average size. However, the size to which the rocks are ground may change from one plant to another plant based on plant flowsheet, how pure of a concentrate is needed and/or other factors. This fine powdered rock 32 is mixed with water, reagents and air bubbles in a flotation cell 40. Valuable minerals, such as the desired metal or other desired product, attach to the air bubbles and float to the top where they are recovered for further processing. This product stream is called the concentrate 4. The concentrate 4 may typically include any one or more of Copper concentrate, Lead concentrate, Zinc concentrate, Nickel concentrate, Molybdenum concentrate, Gold concentrate, Silver concentrate Graphite concentrate, Feldspar concentrate, Fluorspar concentrate, Phosphate concentrate, iron concentrate, Barite concentrate and/or Talc concentrate. The particles that do not attach to the air bubbles are called tailings 6 and drop down in the flotation cell and are recovered as a waste stream. In some cases, the tailings slurry stream from the flotation cell is passed through a hydrocyclone, to segregate fine and coarse piles. The hydrocyclone is adjusted to achieve the desired cut size. The tailings 6 may typically include any one or more of Silicates, Carbonates, Oxides, Sulfides and Clay Minerals. The Silicates may typically include any one or more of Quartz, Feldspar, Sericite, Chlorite, Talc, and Serpentine. The Carbonates may typically include any one or more of Calcite, Dolomite, Ankerite and Barite. The Oxides and Sulfides may typically include any one or more of Pyrite and Bauxite.

FIG. 2 shows a schematic drawing of how mined ore (run of mine rock) is processed by crushing and grinding for mineral liberation, and then subjected to a flotation process to separate concentrate and middlings from the tailings to recover product and produce flotation mining tailings as a by-product. Run of mine (ROM) rock feed 12 will have trace amounts of valuable mineral and most of it is gangue (waste). Waste can be silicates, carbonates, clay, oxides and sulfides. A milling process, which includes crushing the Run of mine (ROM) rock feed 12 to form the rocks 22 of about 1 inch in size and the grinding the rocks 22 of about 1 inch in size to rock particles 32 of about 5 to about 200 μm in size, was performed to liberate valuable mineral from the gangue. During the milling process, some of the valuable mineral is 100% liberated which is called concentrate 4 and the rest of the mineral is partially liberated which is called middlings 5 (has trace amounts of gangue present). The objective of the flotation process in the flotation cell 40 is to recover concentrate 4 and middlings 5 and dispose the gangue as tailings 6. Depending on the efficiency of flotation process, trace amount of middlings 5 might end up in tailings stream 6. Since the rock 12 underwent crushing and grinding, the material in the tailings stream 6 would be in the form of powder.

Typical tailings the invention employs are the waste stream from processing sulfide ores, non-sulfide ores, and industrial minerals to recover product. Sulfide tailings typically contain amounts of silicates, clays, carbonates, pyrite (FeS₂) and Iron (II) sulfide (FeS), which are rejected from the sought-after ores of copper and nickel, as well as coal. Typical sulfide ores are copper sulfide, lead sulfide, zinc sulfide, nickel sulfide, molybdenite, or precious metals. Typical non-sulfide ores are graphite, feldspar, fluorspar, phosphate, and iron ore. Typical industrial materials are Barite and Talc.

Tailings may contain SiO₂ and/or Al₂O₃ as a majority of their content. Copper flotation tailings samples are typically composed of mainly quartz, a small amount of muscovite and feldspars, and a trace amount of pyrite.

The tailings are waste material considered too low grade to be economically process by further flotation for recovering the mineral or metal, for example copper, from copper-containing tailings. For example, the term low-grade as used in relation to copper sulfide-containing material has a low concentration of copper understood to mean an average copper concentration of greater than 0.1% Cu in the feed ore and less than 0.01% Cu in the flotation tailings.

In the case of copper tailings, the tailings are an output of an ore processing plant for recovering copper from a copper sulfide-containing ore that contains copper sulfide-containing material, such as copper sulfide minerals. One example of an ore processing plant is one that includes comminution of mined ore involving a series of crushing and grinding stages and one or more than one flotation circuit for floating copper sulfide minerals from the comminuted ore and producing a valuable concentrate output and a tailings output (a pyrite-containing slurry). Typically, the solids in the tailings are in the form of a slurry of (a) fines, with low concentrations of copper. For example, less than 0.01% Cu, and (b) pyrite-containing particles suspended in water. The pyrite-containing particles may also contain some copper.

In the State of Arizona, the copper mines that produce waste material are porphyry copper mines, where traditionally the host copper containing rock is predominantly silica (SiO₂). The average composition of the porphyry copper mine tailings in Arizona, in weight percentage, has been found to consist of:
Silica Sand (SiO₂): 61%
Lime (CaO): 12%
Aluminum Oxide (Al₂O₃): 7%
Ferrous Oxide (Fe₂O₃): 7%
Pyrite (FeS₂): 3%
Magnesium Oxide (MgO): 1%
Potassium Oxide (K₂0): 2%
Sodium Oxide (Na₂0): trace
Sulfur(S): trace.

The composition analysis of the Arizona copper mine tailings shows that silica sand is in fact found in substantial amounts. The silica is found in a granular state that is substantially equivalent to the granular state to which the silica must be ground and sieved to produce the AAC lightweight building material. The fine granular state of the silica sand in the mine tailings results from a flotation process that produces copper from pulverized copper ore. Similarly, lime is found in substantial amounts in the copper mine tailings. While, no particular data is presently available, mine tailings from other metal ore mines conceivably also contain comparable amounts of silica sand and lime in their mine tailings, especially if the host rock for the other metals is porphyritic.

In situations where low silica containing flotation tailings is employed, then, Zinc tailings from Mississippi Valley Type (MVT) ores are typical. They are low in Silica contentment (less than 5 to 15%) and typically hosted in carbonate rock like limestone and dolostone.

The flotation tailings of mined ore is at least 1 weight percent (wt %), typically at least 10 wt %, more typically at least 25 wt %, furthermore typically at least 50 wt %, of the building composition on a dry (water free) basis, wherein the building composition is a joint compound or a texture coating material. Typically the amount of mining flotation tailings is 55 wt % to 95 wt % on dry (water free) basis for drying type joint compounds, 30 wt % to 50 wt % on dry (water free) basis for setting type joint compounds; and 85 wt % to 95 wt % on dry (water free) basis for textures.

If the building composition is drying-type joint compound or texture coating material, then the tailings of mined ore is at least 25 wt. %, preferably at least 50 wt. %, more preferably at least 75 wt. %, typically 25 to 98 wt. %. For example, if the building composition is drying-type joint compound or texture coating material, then the tailings of mined ore may be about 50 to about 98 wt %, or about 50 to about 95 wt. %, or about 55 to about 95 wt. %, of the building composition on a dry (water free) basis.

If the building composition is drying-type joint compound or texture coating material, then the building composition typically comprises a secondary filler at 0 to about 50 wt %, typically at about 0 wt % to about 25 wt %, more typically at about 3 wt % to about 25 wt %, of the building composition on a dry basis. Typically the tailings of mined ore and the secondary filler total at least 45 wt. %, typically at least 60, at least 75 or at least 80 wt. % of the drying-type joint compound on a dry basis. Typically the texture coating material has an absence of latex.

If the building composition is setting-type joint compound, then the setting-type joint compound further comprises calcium sulfate hemihydrate. The setting-type joint compound typically comprises at least 20 wt. %, for example about 20 to about 80 wt. %, typically about 35 wt. % to about 75 wt. %, or about 35 wt % to about 65 wt %, calcium sulfate hemihydrate on a dry basis. The setting-type joint compound typically comprises about 1 to 60 wt. %, typically about 10 wt. % to about 60 wt. %, or typically about 30 to 60 wt. % or about 30 to 50 wt. %, tailings of mined ore on a dry basis. Typically the total of the calcium sulfate hemihydrate, the tailings of mined ore, and the secondary filler is at least 60 wt %, more typically at least 85 wt. %, for example 85 to 98 wt. %, or for example 85 to 95 wt. %, of the setting-type joint compound on a dry basis.

If the building composition is ready-mixed, setting-type joint compound, then the setting-type joint compound further comprising calcium sulfate hemihydrate, a retarder and water. The ready-mixed, setting-type joint compound typically comprises at least 20 wt. %, for example about 20 to about 80 wt %, typically about 35 wt % to about 75 wt %, or typically about 35 wt % to about 65 wt %, calcium sulfate hemihydrate on a dry basis. The setting-type joint compound typically comprises about 1 to 60 wt %, typically about 10 wt % to about 60 wt %, typically about 30 wt % to about 60 wt %, tailings of mined ore on a dry basis. Typically the total of the calcium sulfate hemihydrate, the tailings of mined ore, and the secondary filler is at least 60 wt %, more typically at least 85 wt %, for example about 85 wt % to about 98 wt %, or for example about 85 wt % to about 95 wt %, of the ready-mixed, setting-type joint compound on a dry basis.

### Secondary (Supplemental) Fillers

The joint compounds and texture coating materials of the present invention may include at least one secondary filler. The joint compounds and texture coating materials of the present invention may have an absence of secondary filler.

The secondary filler is any chemically inert mineral filler other than the tailings of mined ore.

Examples of secondary fillers include: calcium carbonate (or limestone), calcium sulfate dihydrate, calcium sulfate anhydrite, and mixtures thereof. Another source of calcium carbonate is dolomite. Dolomite is an anhydrous carbonate mineral composed of calcium magnesium carbonate, e.g., CaMg(CO₃)₂. Thus, for example, calcium carbonate in an amount of about 50 wt % on a dry basis of the joint compound includes, one or more of calcium carbonate, limestone, and dolomite in an amount of about 50 wt % on a dry basis of the joint compound.

Examples of other secondary fillers also include, but are not limited to, talc, glass micro bubbles, mica, perlite (e.g. expanded perlite), pyrophyllite, silica, calcium sulfate anhydrite, diatomaceous earth, clay (e.g., attapulgite, sepiolite and kaolin), resin microspheres, and mixtures thereof. The expanded perlite can be uncoated expanded perlite. The expanded perlite can be coated expanded perlite which is perlite coated with a hydrophobic coating, for example, a coating containing siloxane or silane. The expanded perlite can be a mixture of coated perlite and uncoated perlite. However, while functioning as chemically inert filler, secondary fillers may also impart specific physical properties to the joint compounds. For example, mica aids in reduced cracking of the joint compound as it dries, and is preferred in amounts of up to 25 wt % on a dry basis. It is also preferred to add clay in amounts of up to about 10 wt % on a dry basis to improve the body and workability of the joint compound, and as a rheology modifier. For example, a preferred secondary filler is clay. One specific clay that is used in this disclosure is attapulgite clay also known as hydrous magnesium aluminum silicate. The clay in amounts of up to about 10 wt % on a dry basis can be used to improve the body and workability of the joint compound, and as a rheology modifier. However, the present invention also contemplates compositions either with reduced clay dosage or without adding clay as an additional ingredient because the tailings typically include clay as explained elsewhere in this specification.

Perlite or expanded perlite is a lightweight filler that may be used where the joint compound (or drying-type, setting-type, ready-mixed drying-type, and/or ready-mixed setting-type) is preferably lightweight. Use of expanded perlite in a lightweight joint compound is taught in U.S. Pat. No. 4,454,267, which is herein incorporated by reference. Expanded perlite is a very lightweight material that contains many cracks and fissures. The perlite may be treated with a hydrophobic coating, for example a hydrophobic coating of silane or siloxane. For example, the perlite can be treated according to the teachings of U.S. Pat. No. 4,525,388 to Rehder et al, which is hereby incorporated by reference, so that the material does not increase in weight due to water absorbed by capillary action. The treated, expanded perlite, when used, is preferably present in concentrations of at least 5 wt % on a dry basis of the joint compound. The expanded perlite may be treated with a hydrophobic coating, such as polydimethyl siloxane or other organo-functional silanes having the general formula R—SiC₃, wherein R is selected from the group consisting of alkoxy and acetoxy such as acrylate, methacrylate, glycidoxy, epoxy propoxy, epoxy cyclohexyl and vinyl and X is selected from the group consisting of halogen, alkoxy and acetoxy. These silicones are hydrophobic film forming compounds which are available in aqueous or organic solvent solution, emulsion or dispersion forms.

Resin microspheres may be used as a filler in place of or in addition to expanded perlite in lightweight formulations. Typical shell resins suitable for use in the present invention are homopolymers, copolymers, or blends of homopolymers and/or copolymers formed one or more of acrylonitrile (“ACN”), vinylidene chloride (“VDC”), or methyl methacrylate (“MMA”) monomers. Particularly preferred resins are polyacrylonitrile (“PACN”), polyvinylidene chloride (“PVDC”), copolymers formed from ACN and VDC, and copolymers found from ACN, VDC, and MMA. The microspheres demonstrate high resiliency to compression without collapse (non-friable) and are able to withstand the exerted shear stress (shear-stability) of a typical joint treatment manufacturing process and subsequent customer preparation.

### Calcium Sulfate Hemihydrate

Setting-type joint compounds and ready-mixed, setting-type joint compounds include calcium sulfate hemihydrate. There are two principal forms used, the alpha and beta crystalline forms. In general, the alpha form is the more expensive of the two and produces a stronger product. The beta form is adequate for many uses and, being less expensive, is more commonly used. For joint compounds of the invention, either type of the hemihydrate may be used including mixtures, but the alpha form is preferred.

### Binders

Any binder that is suitable for use in a joint compound is appropriate for use in joint compounds of the present invention. The texture coating material of the invention typically does not contain latex. However, any binder, other than latex, that is suitable for use in a joint compound is appropriate for use in textures of the present invention.

The binder can enhance the adhesion of the joint compound to its substrate, typically drywall. Preferred binders are soft and pliable rather than being extremely hard. Hard binders are likely to create more fine dust particles compared to pliable polymers.

Examples of binders include, but are not limited to, polyvinyl acetate, polyvinyl alcohol, ethylene vinyl acetate co-polymer, vinyl chlorides, vinyl acrylic co-polymer, styrene acrylics, styrene butadiene, polyacrylamide, polyvinylacrylic, latex emulsions, natural and synthetic starch, pregelatinized starch, casein, and mixtures thereof. There may also be an absence of vinyl acetate. The natural starch, synthetic starch and pregelatinized are preferred for use in textures of the present invention as binders. The texture coating material of the invention typically does not contain polyvinyl acetate, ethylene vinyl acetate co-polymer, vinyl chlorides, vinyl acrylic co-polymer, styrene acrylics, styrene butadiene, polyacrylamide, polyvinylacrylic binders.

For drying-type joint compounds, binders can be included at about 0.5 wt % to about 15 wt % of the joint compound, preferably about 1 wt % to about 10 wt %, and most preferably about 1 wt % to about 8 wt % (all on a dry basis).

For setting-type joint compounds, binders can be included at about 0.5 wt % to about 8 wt % of the joint compound, preferably about 1 wt % to about 8 wt %, and most preferably about 1 wt % to about 4 wt % (all on a dry basis).

For ready-mixed, setting-type joint compounds, binders, when included, can be at about 0.1 wt % to about 8 wt % of the joint compound, preferably about 0.5 wt % to about 6 wt %, and most preferably about 1 wt % to about 4 wt % (all on a dry basis).

For texture coating materials, binders can be included at about 0.5 wt % to about 15 wt %, preferably about 1 wt % to about 10 wt %, and most preferably about 1 wt % to about 8 wt % (all on a dry basis) of the texture coating materials.

For example, latex emulsion binders are often used in joint compounds (drying-type and/or setting-type) and may be included in joint compounds of the invention. Examples include polyvinyl acetate, ethylene vinyl acetate and vinyl acrylic emulsions. The amount used may range from about 1.5 wt % to about 7 wt % on a dry basis of the joint compound, preferably about 2 wt % to about 5.5 wt % on a dry basis.

The weight ratio of total tailings of mined ore and secondary fillers to total binders is preferably in the range of from about 15:1 to about 5:1.

The joint compounds of the present invention may employ one or more latexes, for example one latex as the sole latex with an absence of additional latex, or a combination of latexes wherein their respective glass transition temperatures may be the same or different. Each of the one or more latexes typically has a glass transition temperature in the range of less than 40° C., or less than 30° C., or less than 20° C., or less than 15° C., or less than 10° C., or less than 0° C., or less than −15° C. Each of the one or more latexes typically has a glass transition temperature of greater than about −100° C., greater than about −80° C., greater than about −40° C., or greater than 10° C., for example about 15° C. to less than 40° C. Compositions of the present invention may include mixtures comprising a first binder and a second. For example, the first binder may comprise a first polymer having a glass transition temperature that is equal to or greater than about −10° C. The second binder may comprise a second polymer having a glass transition temperature in the range of about −80° C. to about 10° C. In the case of these two binders the glass transition temperature of the first binder is at least about 5° C. greater than the glass transition temperature of the second binder, and the first and second polymers have the same chemistry. However, the present invention preferably does not use combinations of both first and second binders of compositions of U.S. Pat. No. 9,643,887 to Ayambem et al.

### Polymer Thickeners/Rheology Modifiers

Polymer thickeners are added to the joint compound and the texture coating material of the present invention. After water is added to the composition, the thickener becomes hydrated and swells, thereby thickening the joint compound. Thickeners are useful, for example, in helping to create the body and flow properties commonly associated with joint compounds and the texture coating material. Preferably, the thickener is selected so that it substantially hydrates during the mixing process after water is added to the composition, with little or no hydration of the thickener occurring after mixing is completed, to prevent formation of lumps in the joint compound.

Examples of polymer thickeners include, but are not limited to, ethylhydroxy ethylcellulose, hydroxypropyl methylcellulose, methylhydroxypropyl cellulose, hydroxyethyl cellulose, cellulose-based gums (e.g., xanthan gum, gum Arabic, alginate, pectin, and guar gums), and mixtures thereof.

For drying-type joint compounds and texture coating materials, polymer thickeners can be included at about 0.05 wt % to about 3 wt % on a dry basis of the joint compound, preferably about 0.1 wt % to about 3 wt % on a dry basis, more preferably about 0.1 wt % to about 2 wt % on a dry basis, and most preferably about 0.5 wt % to about 2 wt % on a dry basis.

For setting-type joint compounds, polymer thickeners can be included at about 0.05 wt % to about 2 wt % on a dry basis of the joint compound, preferably about 0.1 wt % to about 2 wt % on a dry basis, and most preferably about 0.1 wt % to about 1 wt % on a dry basis.

For ready-mixed, setting-type joint compounds, polymer thickeners, when included, can be at 0.01 wt % to about 2 wt % on a dry basis of the joint compound, preferably about 0.1 wt % to about 2 wt % on a dry basis, and most preferably about 0.1 wt % to about 1 wt % on a dry basis.

### Set Retarders

Set retarders are included in ready-mixed, setting-type joint compounds. Set retarders are optionally included in texture coating materials (there are no set retarders in textures), drying-type joint compounds and setting-type joint compounds and are considered one of the other additives in Tables 1 and 2.

Set retarders (or set inhibitors or set preventer) slow the chemical setting of the joint compounds to provide ample time to properly apply the joint compound before hardening.

Examples of set retarders include, but are not limited to, polymer compositions including acrylic acid and acrylamide monomer units (e.g., a copolymer (or a mixture of copolymers) of acrylic acid and acrylamide or a blend of a homopolymer of acrylic acid and a homopolymer of acrylamide), as described in U.S. Pat. No. 5,779,786, incorporated herein by reference.

Additional examples of non-calcium bearing phosphate set retarders include, but are not limited to, zinc hexametaphosphate, potassium tripolyphosphate, tetra sodium pyrophosphate, sodium tripolyphosphate, monoammonium phosphate, and monobasic potassium phosphate, as described in U.S. Pat. No. 5,746,822, incorporated herein by reference.

Examples of set retarders include, but are not limited to, polymer compositions including polyacrylic acid and/or a salt of polyacrylic acid, as described in U.S. Pat. No. 6,805,741, incorporated herein by reference.

For ready-mixed, setting-type joint compounds, set retarders can be included at about 0.001 wt % to about 2 wt % on a dry basis of the joint compound, preferably about 0.01 wt % to about 2 wt % on a dry basis, more preferably about 0.1 wt % to about 1 wt % on a dry basis, and most preferably about 0.25 wt % to about 0.75 wt % on a dry basis.

For texture coating materials, drying-type joint compounds and setting-type joint compounds, set retarders, when included, can be at about 0.001 wt % to about 2 wt % on a dry basis of the joint compound, preferably about 0.01 wt % to about 2 wt % on a dry basis, more preferably about 0.1 wt % to about 1 wt % on a dry basis, and most preferably about 0.25 wt % to about 0.75 wt % on a dry basis.

### Set Accelerators

Set accelerators are added to ready-mixed, setting-type joint compounds at the time of use. Set accelerators are included in setting-type joint compounds and optionally included in drying-type joint compounds. No set accelerators are included in textures.

Set accelerators (or set initiators or activators) accelerate and/or initiate setting and/or drying of the joint compounds.

Examples of set initiators include, but are not limited to, metallic salts that provide acidic cations, such as aluminum sulfate, potassium sulfate, calcium sulfate, ferric sulfate, ferric chloride, and mixtures thereof, as described in U.S. Pat. No. 5,779,786, incorporated herein by reference. Another example of set initiators include, but are not limited to, zinc sulfate optionally in combination with iron oxide (e.g., in a weight ratio of 19:1).

Additional examples of set initiators include, but are not limited to, zinc sulfate, aluminum sulfate, sulfuric acid, hydrochloric acid, sodium hydrogen sulfate, potassium hydrogen sulfate, potassium aluminum sulfate, calcium sulfate dihydrate, and mixtures thereof, as described in U.S. Pat. No. 6,805,741, incorporated herein by reference.

Set initiators can optionally also include amine chelating agents.

Set initiators can be added to ready-mixed, setting-type joint compounds at a weight ratio to set retarders of about 1.2:1 to about 6:1, and preferably about 2:1 to about 6:1.

When used, set initiators can be included in or added to drying-type joint compounds and setting-type joint compounds at a weight ratio to set retarders of about 1.2:1 to about 6:1, and preferably about 2:1 to about 6:1.

### Dedusting Agent

The joint compounds of the present invention may optionally include a dedusting agent. The dedusting agents may typically be any of wax emulsions and polymer coated wax core particulates, polyethylene glycol, liquid mineral oils and solid waxes (for example polyethylene glycol wax), wax emulsions, polymer coated wax core particulates, and plasticizer dedusting agent. When included, the amount of wax, oil and/or polyethylene glycol used in a joint compound of the invention is typically in a range of about 0.1 wt % to about 1 wt %, more preferably 0.1 wt % to 0.5 wt % on a dry basis of the joint compound.

The plasticizer dedusting agent may be one or more dibenzoates, e.g., glycol dibenzoates. Typical dibenzoate plasticizer is one or more of glycol dibenzoates, such as diethylene glycol dibenzoate, dipropylene glycol dibenzoate and propylene glycol dibenzoate. The plasticizer dedusting agent may be one or more of hydroxypropyl cellulose (HPC), sorbitol, and related sugar alcohols, polyvinylpyrrolidone, and polymer plasticizers. However, any one or more of these may be absent. The plasticizer dedusting agent may comprise one or more ester plasticizers such as one or more of sebacates, adipates, maleates, such as bis(2-ethylhexyl) adipate (DEHA), dimethyl adipate (DMAD), monomethyl adipate (MMAD), dioctyl adipate (DOA), dibutyl sebacate (DBS), dibutyl maleate (DBM), diisobutyl maleate (DIBM), gluterates, and azelates; trimellitates, such as trimethyl trimellitate (TMTM), tri-(2-ethylhexyl) trimellitate (TEHTM) (TOTM), tri-(n-octyl, n-decyl) trimellitate (ATM), tri-(heptyl, nonyl) trimellitate (LTM), and n-octyl trimellitate (OTM), azelates, and benzoates, 1,2-cyclohexane dicarboxylic acid diisononyl ester, alkyl sulphonic acid phenyl ester (ASE), glycols and polyethers, such as triethylene glycol dihexanoate (3G6, 3GH), tetraethylene glycol diheptanoate (4G7), polymeric plasticizers and polybutene.

However, any one or more of these dedusting agents may be absent.

Dedusting agents may be used in liquid form, dry form, encapsulated liquid form, suspensions and solutions.

The dedusting agents can be mixed either with the joint compound components of the joint compound formulation or a joint compound slurry. Alternatively, the dedusting agent dispersed in an aqueous solvent can be added to the joint compound slurry.

Preferably, when preparing a joint compound, the dedusting agent is dispersed as an aqueous suspension, 0 to about 3 wt %, typically 0 to about 2 wt %, about 0.03 to about 3 wt %, or about 0.05 to about 2 wt % (all on a dry basis).

### Additives

Other additives that can optionally be included in texture coating materials and joint compounds include, but are not limited to, preservatives, fungicides, bactericides, defoaming agents, glycols, humectants, and mixtures thereof. Lecithin can be added but typically there is an absence of lecithin.

Other additives that can optionally be included in texture coating materials and joint compounds include, but are not limited to, rheology modifiers which can include surfactants, thickeners, and/or dispersing aids.

For texture coating materials and drying-type joint compounds the other additives (in total) can be included at up to 10 wt. %, typically about 0.01 wt % to about 10 wt % on a dry basis of the joint compound, and preferably about 0.1 wt % to about 10 wt % on a dry basis.

For setting-type joint compounds and ready-mixed, setting-type joint compounds the other additives (in total) can be included at up to 10 wt. %, typically about 0.01 wt % to about 5 wt % on a dry basis of the joint compound, preferably about 0.01 wt % to about 5 wt % on a dry basis, and most preferably about 0.1 wt % to about 1.0 wt % on a dry basis.

Defoamers reduce or hinder the formation of air bubbles, which may form especially when mixing. Examples of defoamers include, but are not limited to, hydrocarbon-based, silicon-based defoamer, and mixtures thereof.

A glycol can be used in a joint compound to provide functional properties to the joint compound such as wet edge, open time, controlling drying time, and freeze/thaw stability. Examples of glycols include, but are not limited to, diethyl glycol, ethylene glycol, propylene glycol, and mixtures thereof. When included, the amount of glycol used in a joint compound of the invention is preferably in a range of about 0.1 wt % to about 1 wt % or 0.1 wt % to 0.5 wt % or 0.1 wt % to 0.25 wt % on a dry basis of the joint compound.

### Methods of Making and Using the Building Composition of the Invention

The invention provides a method of using the building composition of the invention, comprising applying the building composition to boards, joint tape, and/or another layer of the building composition, wherein the building composition is the joint compound or the texture coating material.

In the method of using the building composition of the invention, the building composition resulting from combining the ingredients of the building composition is applied to any of the boards, joint tape, and/or another layer of the building composition and hardens when exposed to air. When the method applies the building composition which is a joint compound, the method further comprises sanding the hardened joint compound to remove an amount of the hardened joint compound. When the method applies the building composition which is a texture coating material, the texture coating material is typically applied either by using a spray gun or by hand tools such as brushes, trowels, or sponges to achieve desired patterns.

The invention also provides a method of making the building composition of the invention, comprising combining the flotation tailings of mined ore, calcium sulfate hemihydrate (if present), at least one secondary filler (if present), the binder (if present), the polymer thickener, the plasticizer dedusting agent (if present), and the additive (if present) to form a mixture which is the building composition, wherein the building composition is a joint compound or a texture coating material.

The method of making the building composition comprises combining the ingredients of the building composition to make a mixture which is the building composition of the invention.

In particular the method of making the building composition comprises combining:
the tailings of mined ore in an amount of at least 1 weight percent (wt %), typically at least 25 wt %, more typically at least 50 wt %, of the building composition on a dry (water free) basis;
the binder at 0 to about 15 wt % of the building composition on a dry basis;
the polymer thickener at 0 to about 3 wt % of the building composition on a dry basis;
the additive at 0 to about 10 wt % of the building composition on a dry basis;
to form the mixture which is the building composition;
wherein the building composition is a joint compound or a texture coating material.

### Clauses Describing Various Characteristics of the Invention

The following clauses describe aspects of the invention.

Clause A.1. A building composition, wherein the building composition is a joint compound or a texture coating material, comprising a mixture of ingredients comprising:
flotation tailings of mined ore as a primary filler,
wherein the tailings of mined ore is at least 1 weight percent (wt %), typically at least 25 wt %, more typically at least 50 wt %, of the building composition on a dry (water free) basis, typically ranges of:
   55 wt % to 95 wt % of the building composition on dry (water free) basis for drying type joint compound,
   30 wt % to 60 wt % of the building composition on dry (water free) basis for setting type joint compound, and
   85 wt % to 95 wt % of the building composition on dry (water free) basis for textures;
a binder at about 0.5 to about 15 wt %, typically about 0.5 to about 8 wt %, of the building composition on a dry basis;
a polymer thickener at 0 to about 3 wt %, typically about 0.05 to about 3 wt %, of the building composition on a dry basis;
an additive at 0 to about 10 wt % of the building composition on a dry basis.

Clause B.2. The building composition of clause A.1, wherein the tailings of mined ore is about 25 to about 98 wt % of the building composition on a dry (water free) basis.

Clause C.3. The building composition of clause A.1 or B.2,
optionally comprising calcium sulfate hemihydrate;
optionally comprising at least one secondary filler, wherein the secondary filler, if present, preferably comprises any of calcium carbonate, calcium sulfate dihydrate, calcium sulfate anhydrite, or a mixture thereof;
wherein a total amount of:
   a) the tailings of mined ore,
   b) the calcium sulfate hemihydrate, and
   c) the at least one secondary filler,
is at least 45 weight percent (wt %), preferably at least 75 wt %, of the building composition on a dry (water-free) basis.

Clause D.4. The building composition of clause A.1, wherein the flotation tailings of mined ore are particles and wherein particle size of the tailings has 100% passing 50 mesh screen, for example the particle size of the tailings has 100% passing 100 mesh screen.

Clause E.5. The building composition of clause D.4,
wherein the building composition is drying-type joint compound,
wherein the tailings of mined ore is at least 25 wt %, preferably at least 50 wt %, more preferably at least 75 wt %, typically about 25 to about 98 wt % or about 50 to about 95 wt % of the joint compound on a dry basis,
further comprising secondary filler at 0 to about 50 wt % of the joint compound on a dry basis, wherein the secondary filler, if present, comprises any of calcium carbonate, calcium sulfate dihydrate, calcium sulfate anhydrite, or a mixture thereof;
wherein the tailings of mined ore and the secondary filler total at least 45 weight percent (wt %), preferably at least 60 wt %, more preferably at least 75 wt % of the drying-type joint compound on a dry basis;
wherein the binder is about 0.5 to about 15 wt % of the joint compound on a dry basis; and
wherein the polymer thickener is about 0.05 to about 3 wt % of the building composition on a dry basis;
wherein the additive is 0 to about 10 wt % of the building composition on a dry basis.

Clause F.6. The building composition of clause E.5, wherein the building composition is drying-type joint compound and comprises:
the tailings of mined ore at about 55 wt % to about 95 wt % of the drying-type joint compound on a dry basis;
the secondary filler at 0 wt % to about 25 wt % of the drying-type joint compound on a dry basis;
the binder at about 1 wt % to about 10 wt % of the drying-type joint compound on a dry basis;
the polymer thickener at about 0.1 wt % to about 2 wt % of the drying-type joint compound on a dry basis;
the additive at up to 10 wt % of the drying-type joint compound on a dry basis.

Clause G.7. The building composition of clause D.4, wherein the building composition is ready-mix, drying-type joint compound comprising joint compound components and water,
wherein the joint compound components comprise the tailings of mined ore, the binder, the polymer thickener, the additive, and optionally a secondary filler;

wherein the tailings of mined ore is at least 25 wt %, preferably at least 45 wt %, more preferably at least 75 wt %, typically about 50 to about 95 wt % of the joint compound on a dry basis,
wherein the secondary filler is 0 to 50 wt % of the drying-type joint compound on a dry basis, wherein the secondary filler, if present, preferably comprises any of calcium carbonate, calcium sulfate dihydrate, calcium sulfate anhydrite, or a mixture thereof;
wherein the tailings of mined ore and the secondary filler total at least 45 wt. %, preferably at least 75 wt % of the drying-type joint compound on a dry basis;
wherein the binder is about 0.5 to about 15 wt % of the drying-type joint compound on a dry basis;
wherein the polymer thickener is about 0.05 to about 3 wt % of the drying-type joint compound on a dry basis;
wherein the additive is up to 10 wt % of the drying-type joint compound on a dry basis; and
wherein the water is at a weight ratio of water to joint compound components of about 1:3 to about 3:1.

Clause H.8. The building composition of clause G.7, wherein the building composition is the ready-mix, drying-type joint compound and comprises:
the tailings of mined ore at about 50 wt % to about 95 wt % of the drying-type joint compound on a dry basis, wherein the primary filler is calcium sulfate dihydrate;
the secondary filler at 0 wt % to about 25 wt % of the drying-type joint compound on a dry basis;
the binder at about 1 wt % to about 10 wt % of the drying-type joint compound on a dry basis;
the polymer thickener at about 0.1 wt % to about 2 wt % of the drying-type joint compound on a dry basis;
the additive at up to about 10 wt % of the drying-type joint compound on a dry basis; and
the water at the ratio of water to joint compound components of about 1:3 to about 1:1.

Clause I.9. The building composition of clause D.4, wherein the building composition is setting-type joint compound, the setting-type joint compound further comprising calcium sulfate hemihydrate.

Clause J.10. The building composition of clause I.9, wherein the building composition is the setting-type joint compound,
the setting-type joint compound comprising at least 20 wt % calcium sulfate hemihydrate on a dry basis;
wherein the tailings of mined ore is from 1 to 60 wt % of the setting-type joint compound on a dry basis,
the setting-type joint compound further comprising 0 to 25 wt % secondary filler on a dry basis, wherein the secondary filler, if present, preferably comprises any of calcium carbonate, calcium sulfate dihydrate, calcium sulfate anhydrite, or a mixture thereof;
wherein the total of the calcium sulfate hemihydrate, the tailings of mined ore, and the secondary filler is at least 60 wt % of the setting-type joint compound on a dry basis;
the binder is about 0.5 to about 8 wt % of the setting-type joint compound on a dry basis;
the polymer thickener is about 0.05 to about 2 wt % of the setting-type joint compound on a dry basis; and
the additive is up to about 10 wt % of the setting-type joint compound on a dry basis.

Clause K.11. The building composition of clause J.10, wherein the building composition is the setting-type joint compound and comprises:
the calcium sulfate hemihydrate at about 20 wt % to about 80 wt % of the setting-type joint compound on a dry basis;
the tailings of mined ore at about 10 wt % to about 60 wt % of the setting-type joint compound on a dry basis;
wherein total calcium sulfate hemihydrate, tailings of mined ore, and secondary filler is at least 85 wt % of the setting-type joint compound on a dry basis.

Clause L. 12. The building composition of clause D.4, wherein the building composition is ready-mixed type, setting-type joint compound, wherein the ready-mixed type, setting-type joint compound further comprises calcium sulfate hemihydrate, a retarder, and water.

Clause M. 13. The building composition of clause L. 12, wherein the building composition is ready-mixed, setting-type joint compound,
wherein the ready-mixed, setting-type joint compound comprises joint compound components and water;
wherein the joint compound components comprise the tailings of mined ore, the binder, the polymer thickener, the dedusting agent, the additive, and further comprise calcium sulfate hemihydrate, a set retarder, and optionally a secondary filler, wherein the secondary filler, if present, preferably comprises any of calcium carbonate, calcium sulfate dihydrate, calcium sulfate anhydrite, or a mixture thereof;
wherein:
the calcium sulfate hemihydrate is at least 20 weight percent (wt %) of the ready-mixed, setting-type joint compound on a dry basis;
the tailings of mined ore is about 1 wt % to about 60 wt % of the ready-mixed, setting-type joint compound on a dry basis;
the secondary filler is 0 wt % to about 25 wt % of the ready-mixed, setting-type joint compound on a dry basis;
the total calcium sulfate hemihydrate, tailings of mined ore, and the secondary filler is at least 60 wt % of the ready-mixed, setting joint compound on a dry basis;
the set retarder is about 0.001 wt % to about 2 wt % of the ready-mixed, setting-type joint compound on a dry basis;
the binder is about 0.5 wt % to about 8 wt % of the ready-mixed, setting-type joint compound on a dry basis;
the polymer thickener is about 0.05 wt % to about 2 wt % of the ready-mixed, setting-type joint compound on a dry basis;
the additive is up to 10 wt % of the ready-mixed, setting-type joint compound on a dry basis; and
the water is at a ratio of water to joint compound components of about 1:3 to about 3:1.

Clause N.14. The building composition of clause M.13, wherein the joint compound is the ready-mixed, setting-type joint compound and comprises:
the calcium sulfate hemihydrate at about 35 wt % to about 65 wt % of the ready-mixed, setting-type joint compound on a dry basis;
the tailings of mined ore at about 30 wt % to about 60 wt % of the ready-mixed, setting-type joint compound on a dry basis,
wherein total calcium sulfate hemihydrate, tailings of mined ore and secondary filler is at least 88 wt % of the setting-type joint compound on a dry basis.

Clause O.15. The building composition of clause A.1, wherein the building composition is the texture coating material,
wherein the tailings of mined ore is at least 25 wt %, preferably at least 50 wt %, more preferably at least 75 wt %, typically about 25 to about 98 wt % or about 85 to about 95 wt % of the texture coating material on a dry basis;
0.05 wt. % to 3 wt. % polymer thickener;
0.5 wt. % to 8 wt. % binder;
wherein the texture coating material further comprises water;
wherein the texture coating material has an absence of latex.

Clause P.16. The building composition of clause O15, wherein the building composition is the texture coating material, and
comprises the tailings of mined ore at about 25 wt % to about 98 wt % of the texture coating material on a dry basis; and
further comprises secondary filler at 0 to about 50 wt % of the texture coating material on a dry basis, wherein the secondary filler, if present, comprises any of calcium carbonate, calcium sulfate dihydrate, calcium sulfate anhydrite, or a mixture thereof;
wherein the tailings of mined ore and the secondary filler total at least 75 wt % of the texture coating material on a dry basis; and
the water is at a ratio of water to joint compound components of about 1:3 to about 5:1.

Clause Q.17. The building composition of any of clauses A.1 to P.16, wherein there is an absence of secondary filler.

Clause R.18. A method of using the building composition of any of clauses A1 to Q17, comprising applying the building composition to boards, joint tape, and/or another layer of the building composition.

Clause S.19. A method of making the building composition of any of clauses A.1 to Q.17, comprising combining:
the tailings of mined ore in an amount of at least 1 weight percent (wt %), typically at least 25 wt %, more typically at least 50 wt %, of the building composition on a dry (water free) basis;
the binder at 0 to about 15 wt % of the building composition on a dry basis;
the polymer thickener at 0 to about 3 wt % of the building composition on a dry basis;
the additive at 0 to about 10 wt % of the building composition on a dry basis;
to form the mixture;
wherein the building composition is a joint compound or a texture coating material.

### EXAMPLES

In the examples herein, as mentioned above, percentages of compositions or product formulae are in weight percentages, unless otherwise expressly stated. The reported measurements also in approximate amounts unless expressly stated, for example, approximate percentages, weights, temperatures, distances or other properties.

Copper flotation tailings was the filler in the formulations of the inventive examples, unless otherwise indicated.

The inventive examples, unless otherwise indicated, employed copper flotation tailings sample received in a slurry form of about 60% solids. The water is decanted, and material is dried in a Climate 95° F./10% RH room for several days. Upon drying, agglomerated cakes are broken down using a rolling pin.

For the use of tailings as filler in ready-mix drying-type joint compounds and setting type joint compounds of the inventive examples, the tailings were screened to 100% passing 200 mesh. For the use of tailings in textures of the inventive examples, the tailings were screened to 100% passing 50 mesh.

Calcium carbonate was used as the filler in the control formulations. In particular, in the control formulations, calcium carbonate was used as the filler. There is no calcium sulfate hemihydrate in the formulations for drying type joint compounds or drying type textures. Calcium sulfide hemihydrate is used in setting type compounds in addition to Calcium carbonate.

The textures tested in inventive examples were drying type formulations.

Calcium carbonate was replaced with flotation tailings as filler in the examples of the invention formulations. TABLE 5 shows the XRF results for the copper flotation tailings of the examples.

TABLE 5
XRF results for copper flotation tailings

| Component | Mass % (LOI Corrected) |
|---|---|
| CO2 | 17.9616 |
| Na2O | 0.4293 |
| MgO | 0.6348 |
| Al2O3 | 10.3371 |
| SiO2 | 63.6834 |
| P2O5 | 0.0586 |
| SO3 | 0.1558 |
| K2O | 3.4248 |
| CaO | 0.4810 |
| TiO2 | 0.1796 |
| Fe2O3 | 2.2911 |
| NiO | 0.0059 |
| CuO | 0.0380 |
| ZnO | 0.0125 |
| Ga2O3 | 0.0055 |
| Br | 0.0861 |
| SrO | 0.0077 |
| Y2O3 | 0.0051 |
| ZrO2 | 0.0298 |
| LOI (1000° C.) | 3.08 |

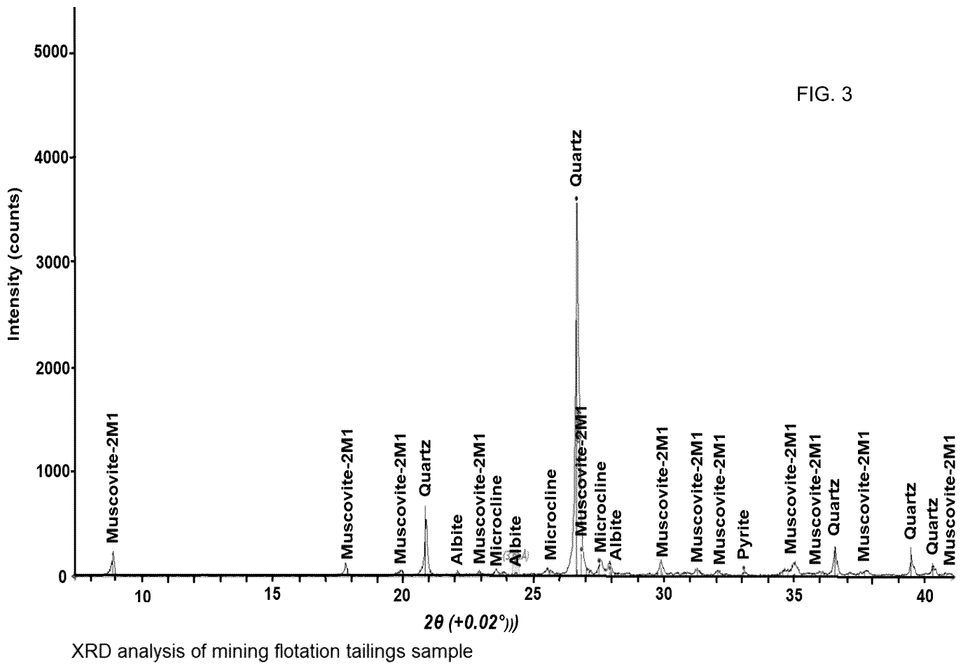

FIG. 3 is a plot of XRD analysis of a copper mining flotation tailings sample. All copper flotation tailings samples were composed of mainly quartz, a small amount of muscovite and feldspars, and a trace amount of pyrite. FIG. 3 shows peaks for Quartz, Muscovite-2M1, Microcline (also known as potassium tecto-alumotrisilicate), Pyrite and Albite. Quartz is SiO₂. Muscovite-2M1 is KAl₂(Si₃Al)O₁₀(OH,F)₂. Microcline (potassium tecto-alumotrisilicate) is K(Al₂Si₃O₈). Pyrite is FeS_{1.92}. Albite is Na(Al₂Si₃O₈).

### Example 1—Ready-Mix Drying Type Joint Compound with Copper Flotation Tailings as Filler

TABLE 6 shows the Testing Flotation Tailings in Ready-mix drying type joint compound.

TABLE 6
Testing Flotation Tailings in Ready-mix:

| | | | Copper Flotation | |
|---|---|---|---|---|
| | Carbonate Filler | | Tailings Filler | |
| | Control A | | Inventive B | |
| Sample Identification | % | grams | % | grams |
| calcium carbonate | 44.91% | 804.50 | — | — |
| Copper Tailings | — | — | 43.46% | 804.50 |
| Expanded perlite | 5.44% | 97.50 | 5.27% | 97.50 |
| hydrous magnesium | 2.44% | 43.75 | 2.36% | 43.75 |
| aluminum silicate clay | | | | |
| hydroxyethyl cellulose | 0.35% | 6.25 | 0.34% | 6.25 |
| (HEC) rheology modifier/ | | | | |
| thickener | | | | |
| hydroxypropyl methyl | 0.18% | 3.25 | 0.18% | 3.25 |
| cellulose (HPMC) rheology | | | | |
| modifier/thickener | | | | |
| Polyvinyl Alcohol | 0.15% | 2.75 | 0.15% | 2.75 |
| starch | 0.15% | 2.75 | 0.15% | 2.75 |
| Dry Weight (g) | | 960.94 | | 960.94 |
| latex | 2.62% | 47.00 | 2.54% | 47.00 |
| bactericide | 0.17% | 3.00 | 0.16% | 3.00 |
| Water | 43.56% | 780 | 45.39% | 840 |
| Percent non-volatile/ | 100.00% | 1791.19 | 100.00% | 1851.19 |
| Total weight (g) | | | | |

### Example 2—Ready-Mix Drying Type Joint Compound with Copper Flotation Tailings as Filler by Laddering Down the Hydrous Magnesium Aluminum Silicate Clay Dosage

Example 1 shows using equal amounts of hydrous magnesium aluminum silicate (clay) in the only calcium carbonate or only copper flotation tailings examples. However, the present invention also contemplates compositions either with reduced clay dosage or without adding clay as an additional ingredient because the tailings typically include clay as explained elsewhere in this specification.

TABLE 13 shows the Testing Flotation Tailings in Ready-mix drying type joint compound with decreasing amounts of hydrous magnesium aluminum silicate clay. In TABLE 7, 75% hydrous magnesium aluminum silicate clay means 75% of the hydrous magnesium aluminum silicate clay used in the example Inventive B. 50% hydrous magnesium aluminum silicate clay means 50% of the hydrous magnesium aluminum silicate clay used in the example Inventive B. 0% hydrous magnesium aluminum silicate clay means 0% of the hydrous magnesium aluminum silicate clay used in the example Inventive B. 100% Copper Flotation Tailings Filer means 100% of the Copper Flotation Tailings Filer used in the example Inventive B.

TABLE 7
Testing Flotation Tailings in Ready-mix:

| | 100% Copper | | 100% Copper | | 100% Copper | |
|---|---|---|---|---|---|---|
| | Flotation Tailings | | Flotation Tailings | | Flotation Tailings | |
| | Filler; 75% hydrous | | Filler; 50% hydrous | | Filler; 0% hydrous | |
| | magnesium aluminum | | magnesium aluminum | | magnesium aluminum | |
| | silicate clay | | silicate clay | | silicate clay | |
| Sample | Inventive C | | Inventive D | | Inventive E | |
| Identification | % | grams | % | grams | % | grams |
| calcium | — | — | — | — | — | — |
| carbonate | | | | | | |
| Copper Tailings | 45.10% | 804.50 | 45.55% | 804.50 | 47.07% | 804.50 |
| Expanded perlite | 5.47% | 97.50 | 5.52% | 97.50 | 5.70% | 97.50 |
| hydrous | 1.84% | 32.81 | 1.24% | 21.88 | 0.00% | 0.00 |
| magnesium | | | | | | |
| aluminum silicate | | | | | | |
| clay | | | | | | |
| hydroxyethyl | 0.35% | 6.25 | 0.35% | 6.25 | 0.37% | 6.25 |
| cellulose (HEC) | | | | | | |
| rheology | | | | | | |
| modifier/thickener | | | | | | |
| hydroxypropyl | 0.18% | 3.25 | 0.18% | 3.25 | 0.19% | 3.25 |
| methyl cellulose | | | | | | |
| (HPMC) rheology | | | | | | |
| modifier/thickener | | | | | | |
| Polyvinyl Alcohol | 0.15% | 2.75 | 0.16% | 2.75 | 0.16% | 2.75 |
| starch | 0.15% | 2.75 | 0.16% | 2.75 | 0.16% | 2.75 |
| Dry Weight (g) | | 950.00 | | 939.06 | | 917.19 |
| latex | 2.63% | 47.00 | 2.66% | 47.00 | 2.75% | 47.00 |
| bactericide | 0.17% | 3.00 | 0.17% | 3.00 | 0.18% | 3.00 |
| Water | 43.83% | 782 | 43.88% | 775 | 43.30% | 740 |
| Percent non- | 100.00% | 1784.00 | 100.00% | 1766.06 | 100.00% | 1709.19 |
| volatile/Total | | | | | | |
| weight (g) | | | | | | |

### Example 3—Testing Flotation Tailings in Setting Type Compounds

The Copper flotation tailings such as used in Example 1 and 2 were also used as the filler in the inventive trial formulation for setting type joint compounds. TABLE 8 shows the tested formulations.

TABLE 8

Setting type joint
compound formulations

| | Control F | Inventive |
|---|---|---|
| Raw Materials | (g) | Trial G (g) |
| calcium carbonate | 1001.4 | 0 |
| Copper Tailings | 0 | 1001.4 |
| Expanded Perlite | 146 | 146 |
| calcium sulfate hemihydrate | 1175 | 1175 |
| starch | 19.7 | 19.7 |
| Attapulgite clay | 50 | 50 |
| polyvinyl alcohol | 5 | 5 |
| hydroxypropyl methyl cellulose ether | 8.4 | 8.4 |
| Lime | 1 | 1 |
| accelerator | 1 | 1 |
| Retarder | 1.4 | 1.4 |
| Batch Weight | 2408.90 | 2408.90 |

### Example 4—Testing Flotation Tailings in Textures

The Copper flotation tailings such as used in Example 1, 2 and 3 were also used as the filler in the inventive trial formulation I and J for texture coating material of the drying type. However, Inventive Trial Formulation I, used Copper flotation tailings that were unscreened “as is” (the Copper flotation tailings were used as received and the material was just dried prior to use). Inventive Trial Formulation J used the fraction of the Copper flotation tailings that passed 100% through 50 mesh. For Inventive Trial Formulation J, the Copper flotation tailings were screened at 50 mesh to remove grit particles.

TABLE 9 shows the tested formulations in wt. %.

TABLE 9
(wt. %)

| | | Inventive | Inventive |
|---|---|---|---|
| | Control H | Trial I | Trial J |
| Calcium carbonate | 91.00% | 0% | 0% |
| Copper Tailings (as is) | 0% | 91.00% | 0% |
| Copper Tailings (−50 mesh) | 0% | 0% | 91.00% |
| Mica | 3.28% | 3.28% | 3.28% |
| Hydrous magnesium | 3.28% | 3.28% | 3.28% |
| aluminum silicate clay | | | |
| Starch | 1.64% | 1.64% | 1.64% |
| Guar gum | 0.23% | 0.23% | 0.23% |
| Hydroxypropyl methyl | 0.25% | 0.25% | 0.25% |
| cellulose (HPMC) rheology | | | |
| modifier/thickener | | | |
| Sorbitol | 0.10% | 0.10% | 0.10% |
| Defoamer | 0.13% | 0.13% | 0.13% |
| Bactericide | 0.10% | 0.10% | 0.10% |
| Total Weight | 100% | 100% | 100% |

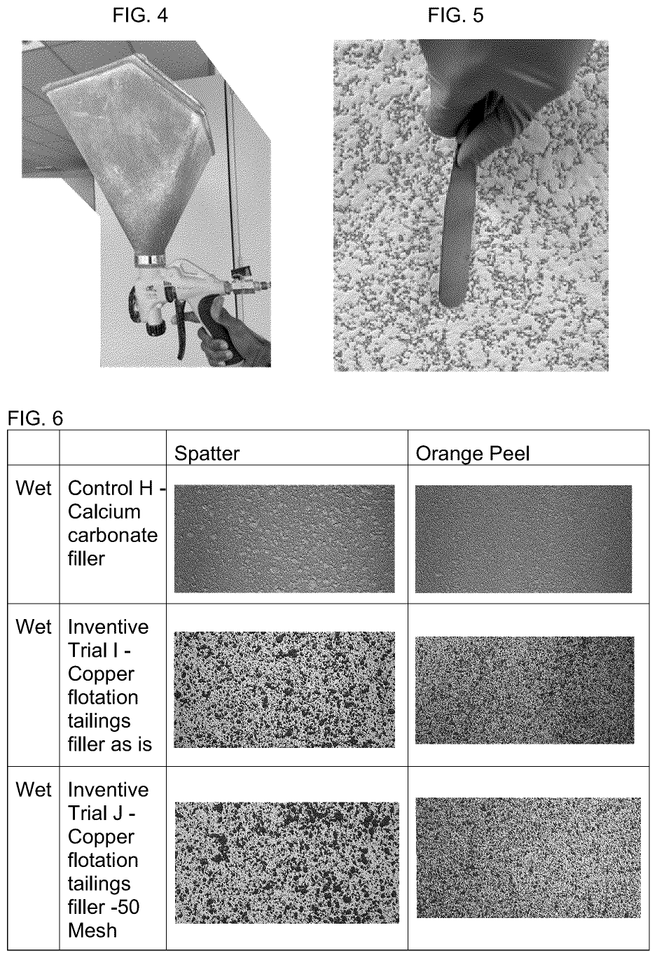

To test applying spatter these texture formulations were applied to a board surface as a spray @ 40 psi, with a spray gun, 7/16″ opening. The spray gun is shown in FIG. 4. The spray gun has a hand held sprayer provided with a bin and activated with a trigger. The texture slurry is present in the bin. As the trigger is pressed texture is sprayed on the walls and ceilings.

To test applying an Orange Peel coating these texture formulations were also applied to a wall board surface as a spray @ 60 psi, with a spray gun, ¼″ opening. Orange peel is a wall or ceiling texture that is named after its resemblance to the skin of an orange citrus fruit. Splatter and Orange Peel are terms of art.

A spatula, shown in FIG. 5, was also used to scrape over the dry texture surface. Based on the amount of material that comes off the wall, trial formulations hardness is judged in comparison to that of the control.

FIG. 6 shows the Splatter and Orange Peel results of the texture while still wet after application to the board.

Conclusions from testing Copper flotation tailings as filler in texture formulations: Copper flotation tailings can be used as a filler without screening or screening at 50 mesh with comparable results to that of the control.

While particular versions of the invention have been shown and described, it will be appreciated by those skilled in the art that changes and modifications may be made thereto without departing from the invention in its broader aspects and as set forth in the following claims.

1. A building composition, wherein the building composition is a joint compound or a texture coating material, comprising a mixture of ingredients comprising:
flotation tailings of mined ore as a primary filler,
wherein the tailings of mined ore is at least 1 weight percent (wt %) of the building composition on a dry (water free) basis, typically ranges of:
a binder at about 0.5 to about 15 wt % of the building composition on a dry basis;
a polymer thickener at 0 to about 3 wt % of the building composition on a dry basis;
an additive at 0 to about 10 wt % of the building composition on a dry basis.

2. The building composition of claim 1, wherein the tailings of mined ore is about 25 to about 98 wt % of the building composition on a dry (water free) basis.

3. The building composition of claim 1,
optionally comprising calcium sulfate hemihydrate;
optionally comprising at least one secondary filler;
wherein a total amount of:
a) the tailings of mined ore,
b) the calcium sulfate hemihydrate, and
c) the at least one secondary filler,
is at least 45 weight percent (wt %) of the building composition on a dry (water-free) basis.

4. The building composition of claim 1, wherein the flotation tailings of mined ore are particles and wherein particle size of the tailings has 100% passing 50 mesh screen.

5. The building composition of claim 4,
wherein the building composition is drying-type joint compound,
wherein the tailings of mined ore is at least 25 wt % of the joint compound on a dry basis,
further comprising secondary filler at 0 to about 50 wt % of the joint compound on a dry basis, wherein the secondary filler, if present, comprises any of calcium carbonate, calcium sulfate dihydrate, calcium sulfate anhydrite, or a mixture thereof;
wherein the tailings of mined ore and the secondary filler total at least 45 weight percent (wt %) of the drying-type joint compound on a dry basis;
wherein the binder is about 0.5 to about 15 wt % of the joint compound on a dry basis; and
wherein the polymer thickener is about 0.05 to about 3 wt % of the building composition on a dry basis;
wherein the additive is 0 to about 10 wt % of the building composition on a dry basis.

6. The building composition of claim 5, wherein the building composition is drying-type joint compound and comprises:
the tailings of mined ore at about 55 wt % to about 95 wt % of the drying-type joint compound on a dry basis;
the secondary filler at 0 wt % to about 25 wt % of the drying-type joint compound on a dry basis;
the binder at about 1 wt % to about 10 wt % of the drying-type joint compound on a dry basis;
the polymer thickener at about 0.1 wt % to about 2 wt % of the drying-type joint compound on a dry basis;
the additive at up to 10 wt % of the drying-type joint compound on a dry basis.

7. The building composition of claim 4, wherein the building composition is ready-mix, drying-type joint compound comprising joint compound components and water,
wherein the joint compound components comprise the tailings of mined ore, the binder, the polymer thickener, the additive, and optionally a secondary filler;
wherein the tailings of mined ore is at least 25 wt % of the joint compound on a dry basis,
wherein the secondary filler is 0 to 50 wt % of the drying-type joint compound on a dry basis;
wherein the tailings of mined ore and the secondary filler total at least 45 wt. % of the drying-type joint compound on a dry basis;
wherein the binder is about 0.5 to about 15 wt % of the drying-type joint compound on a dry basis;
wherein the polymer thickener is about 0.05 to about 3 wt % of the drying-type joint compound on a dry basis;
wherein the additive is up to 10 wt % of the drying-type joint compound on a dry basis; and
wherein the water is at a weight ratio of water to joint compound components of about 1:3 to about 3:1.

8. The building composition of claim 7, wherein the building composition is the ready-mix, drying-type joint compound and comprises:
the tailings of mined ore at about 50 wt % to about 95 wt % of the drying-type joint compound on a dry basis, wherein the primary filler is calcium sulfate dihydrate;
the secondary filler at 0 wt % to about 25 wt % of the drying-type joint compound on a dry basis;
the binder at about 1 wt % to about 10 wt % of the drying-type joint compound on a dry basis;
the polymer thickener at about 0.1 wt % to about 2 wt % of the drying-type joint compound on a dry basis;
the additive at up to about 10 wt % of the drying-type joint compound on a dry basis; and
the water at the ratio of water to joint compound components of about 1:3 to about 1:1.

9. The building composition of claim 4, wherein the building composition is setting-type joint compound, the setting-type joint compound further comprising calcium sulfate hemihydrate.

10. The building composition of claim 9, wherein the building composition is the setting-type joint compound,
the setting-type joint compound comprising at least 20 wt % calcium sulfate hemihydrate on a dry basis;
wherein the tailings of mined ore is from 1 to 60 wt % of the setting-type joint compound on a dry basis,
the setting-type joint compound further comprising 0 to 25 wt % secondary filler on a dry basis;
wherein the total of the calcium sulfate hemihydrate, the tailings of mined ore, and the secondary filler is at least 60 wt % of the setting-type joint compound on a dry basis;
the binder is about 0.5 to about 8 wt % of the setting-type joint compound on a dry basis;
the polymer thickener is about 0.05 to about 2 wt % of the setting-type joint compound on a dry basis; and
the additive is up to about 10 wt % of the setting-type joint compound on a dry basis.

11. The building composition of claim 10, wherein the building composition is the setting-type joint compound and comprises:
the calcium sulfate hemihydrate at about 20 wt % to about 80 wt % of the setting-type joint compound on a dry basis;
the tailings of mined ore at about 10 wt % to about 60 wt % of the setting-type joint compound on a dry basis;
wherein total calcium sulfate hemihydrate, tailings of mined ore, and secondary filler is at least 85 wt % of the setting-type joint compound on a dry basis.

12. The building composition of claim 4, wherein the building composition is ready-mixed type, setting-type joint compound, wherein the ready-mixed type, setting-type joint compound further comprises calcium sulfate hemihydrate, a retarder, and water.

13. The building composition of claim 12, wherein the building composition is ready-mixed, setting-type joint compound,
wherein the ready-mixed, setting-type joint compound comprises joint compound components and water;
wherein the joint compound components comprise the tailings of mined ore, the binder, the polymer thickener, the dedusting agent, the additive, and further comprise calcium sulfate hemihydrate, a set retarder, and optionally a secondary filler;
wherein:
the calcium sulfate hemihydrate is at least 20 weight percent (wt %) of the ready-mixed, setting-type joint compound on a dry basis;
the tailings of mined ore is about 1 wt % to about 60 wt % of the ready-mixed, setting-type joint compound on a dry basis;
the secondary filler is 0 wt % to about 25 wt % of the ready-mixed, setting-type joint compound on a dry basis;
the total calcium sulfate hemihydrate, tailings of mined ore, and the secondary filler is at least 60 wt % of the ready-mixed, setting joint compound on a dry basis;
the set retarder is about 0.001 wt % to about 2 wt % of the ready-mixed, setting-type joint compound on a dry basis;
the binder is about 0.5 wt % to about 8 wt % of the ready-mixed, setting-type joint compound on a dry basis;
the polymer thickener is about 0.05 wt % to about 2 wt % of the ready-mixed, setting-type joint compound on a dry basis;
the additive is up to 10 wt % of the ready-mixed, setting-type joint compound on a dry basis; and
the water is at a ratio of water to joint compound components of about 1:3 to about 3:1.

14. The building composition of claim 13, wherein the joint compound is the ready-mixed, setting-type joint compound and comprises:
the calcium sulfate hemihydrate at about 35 wt % to about 65 wt % of the ready-mixed, setting-type joint compound on a dry basis;
the tailings of mined ore at about 30 wt % to about 60 wt % of the ready-mixed, setting-type joint compound on a dry basis;
wherein total calcium sulfate hemihydrate, tailings of mined ore and secondary filler is at least 88 wt % of the setting-type joint compound on a dry basis.

15. The building composition of claim 1, wherein the building composition is the texture coating material,
wherein the tailings of mined ore is at least 25 wt % of the texture coating material on a dry basis;
wherein the polymer thickener is 0.05 wt. % to 3 wt. % of the texture coating material on a dry basis; and
wherein the binder is 0.5 wt. % to 8 wt. % of the texture coating material on a dry basis;
wherein the texture coating material further comprises water;
wherein the texture coating material has an absence of latex.

16. The building composition of claim 15, wherein the building composition is the texture coating material, and
comprises the tailings of mined ore at about 25 wt % to about 98 wt % of the texture coating material on a dry basis; and
further comprises secondary filler at 0 to about 50 wt % of the texture coating material on a dry basis;
wherein the tailings of mined ore and the secondary filler total at least 75 wt % of the texture coating material on a dry basis; and
the water is at a ratio of water to joint compound components of about 1:3 to about 5:1.

17. The building composition of claim 1, wherein there is an absence of secondary filler.

18. A method of using the building composition of claim 1, comprising applying the building composition to boards, joint tape, and/or another layer of the building composition.

19. A method of making the building composition of claim 1, comprising combining:
the tailings of mined ore in an amount of at least 1 weight percent (wt %) of the building composition on a dry (water free) basis;
the binder at 0 to about 15 wt % of the building composition on a dry basis;
the polymer thickener at 0 to about 3 wt % of the building composition on a dry basis;
the additive at 0 to about 10 wt % of the building composition on a dry basis;
to form the mixture;
wherein the building composition is a joint compound or a texture coating material.

20. The building composition of claim 1, wherein the tailings of mined ore is:
55 wt % to 95 wt % of the building composition on dry (water free) basis for building composition that is a drying type joint compound,
30 wt % to 60 wt % of the building composition on dry (water free) basis for building composition that is a setting type joint compound, and
85 wt % to 95 wt % of the building composition on dry (water free) basis for building composition that is a texture coating material.
